(19) United States
(12) Patent Application Publication
(10) Pub. No.: US 2026/0251518 A1
(43) Pub. Date: Aug. 27, 2026

(54) FORMWORK PRESSURE MEASUREMENT DEVICE AND MONITORING SYSTEM

(71) Applicant: IQM SYSTEMS PTY LTD, Moorebank, New South Wales (AU)

(72) Inventor: Penglei DAI, Moorebank, New South Wales (AU)

(21) Appl. No.: 19/162,801

(22) PCT Filed: Mar. 5, 2024
(86) PCT No.: PCT/AU2024/050176

§ 371 Date: Sep. 5, 2025

(30) Foreign Application Priority Data
Mar. 5, 2023 (AU) 2023900579

(51) Int. Cl. G01L 9/04; H04L 51/046; H04L 51/58

(52) U.S. Cl. CPC G01L 9/04; H04L 51/046; H04L 51/58

(57) ABSTRACT

A formwork pressure measurement device (10, 14) has a pressure transmitter (18, 32) and a flange (20, 40). The pressure transmitter is adapted to be located at a rear side of a formwork (12, 16) and has a first engagement part (30, 36) and a pressure sensor head (22, 41). The flange is adapted to be located in a through-hole (42) of the formwork an has a second engagement part (38). In use, the first and second engagement parts are engaged together so that the pressure sensing head is at least partly surrounded by the flange and can measure the pressure of the concrete on the formwork.

### TECHNICAL FIELD

The present disclosure relates to concrete formwork pressure measurement devices and pressure signal transmitter devices for use as a concrete formwork safety monitoring system.

In particular, the present invention relates to the use of such devices in a formwork safety monitoring system operating in construction projects.

### BACKGROUND OF THE INVENTION

Concrete formwork is a mould or frame that holds wet concrete (poured into the formwork) until it dries and creates the desired structure that suits the purposes of a construction project. Concrete formwork can be made of heavy-duty aluminium, steel, plastic, plywood, or timber. Concrete formwork is widely used in the construction industry, including building construction (residential, commercial, airports, etc.), bridge construction, highway construction, and tunnel construction.

Concrete pressure is the force of the concrete applied to the face of the formwork. Typically, it is resisted by through-ties on double sided formwork or with diagonal props on single sided formwork. Determining concrete lateral pressures is based on a range of factors, including temperature of the concrete, weight or density of the concrete, method of consolidating the concrete, and depth of placement.

Depending on the formwork material and overall structure, there is a pressure limit that cannot be exceeded when the wet (or fluid) concrete is poured against the formwork in a construction site. For typical formwork structures used to construct road tunnels, for example, the maximum allowable pressure is 80 kPa in the ceiling section. Exceeding the maximum concrete pressure may cause an overload on the formwork structure, thereby leading to a serious collapse accident on the construction site.

It is a motivation of the present inventor to provide devices which can measure the pressure on formwork and can transmit signals representing those pressures wirelessly to a monitoring system for monitoring the concrete pressure in real time.

### SUMMARY OF INVENTION

It is an object of the present invention to overcome or at least substantially ameliorate one or more of the above disadvantages, or to provide a useful alternative.

According to the present invention, there is provided a formwork pressure measurement device comprising:
(a) a pressure transmitter adapted to be located at a rear side of a formwork, the pressure transmitter having a first engagement part and a pressure sensing head, and
(b) a flange adapted to be located in a through-hole of the formwork, the flange having a second engagement part,

wherein, in use, the first and second engagement parts are engaged together so that the pressure sensing head is at least partly surrounded by the flange and can measure the pressure of the concrete on the formwork.

Preferably, the pressure sensing head of the pressure transmitter, and an internal flange part of the flange, face a hollow space where wet concrete is to be poured against a front side of the formwork.

It is preferred that an external part of the flange is abutted against the rear side of the formwork.

In a preferred form, the external part of the flange is secured to the rear side of the formwork by screws passed through mounting holes in the flange.

The first and second engagement parts are preferably engaged together by screwing a male threaded part of the pressure transmitter into an internally partly-threaded part of the flange.

Preferably, the pressure sensing head of the pressure transmitter, and an external rim of the flange, face a hollow space where wet concrete is to be poured against a front side of the formwork.

It is preferred that the pressure transmitter has an extender rod, and there is a male threaded part adjacent a free end of the extender rod.

In a preferred form, the first and second engagement parts are engaged together by screwing a male threaded part of the extender rod into an internally partly-threaded part of the flange.

The flange is preferably inserted into the through-hole of the formwork from a front side of the formwork, and the pressure transmitter is inserted into the through-hole from the rear side.

Preferably, the pressure transmitter is a strain gauge pressure transmitter.

It is preferred that the pressure sensing head of the strain gauge pressure transmitter comprises an elastic unit, wherein a plurality of strain gauges are located at a projecting surface of the elastic unit.

In a preferred form, the pressure transmitter is connected via a direct electrical cable to a formwork pressure signal transmitter device.

According to another aspect of the invention, there is provided a formwork pressure signal transmitter device comprising:
(a) means for receiving a pressure value from the aforementioned formwork pressure measurement device, and
(b) means for wirelessly transmitting the pressure value as a signal in real time to a monitoring system for monitoring the concrete pressure in real time.

According to yet another aspect of the invention, there is provided a method of measuring and transmitting the pressure of wet concrete against formwork, the method comprising:
(a) using the aforementioned formwork pressure measurement device to measure the concrete pressure,
(b) connecting the formwork pressure measurement device to the aforementioned formwork pressure signal transmitter device, and
(c) sending a signal from the formwork pressure signal transmitter device representative of the measured concrete pressure wirelessly and in real time to a monitoring system.

The method preferably further includes the step of sending one or more electronic messages by SMS notification and/or email to one or more recipients recorded in a database in response to the pressure measured by the formwork pressure measurement device reaching an excessive pressure value.

According to still another aspect of the invention, there is provided a monitoring system for determining if a specific concrete pressure value has been reached when pouring concrete against formwork, the system comprising:
(a) a plurality of the aforementioned formwork pressure measurement devices located on the formwork,
(b) an aforementioned formwork pressure signal transmitter device connected to each of the formwork pressure measurement devices, and
(c) a remote server for receiving wirelessly and in real time a pressure value as a signal so that a user is alerted that the specific concrete pressure value has been reached.

There has been thus outlined, rather broadly, the more important features of the invention in order that the detailed description thereof that follows may be better understood and put into practical effect, and in order that the present contribution to the art may be better appreciated.

There are additional features of the invention that will be described hereinafter. As such, those skilled in the art will appreciate that the concept, upon which the disclosure is based, may be readily utilized as the basis for designing other structures, assemblies, method steps and system configurations for carrying out the objects of the present invention. It is important, therefore, that the broad outline of the invention described above be regarded as including such equivalent features insofar as they do not depart from the spirit and scope of the present invention.

### BRIEF DESCRIPTION OF DRAWINGS

FIG. 1 is a perspective front view of a plywood formwork through which an embodiment of a formwork pressure measurement device of the invention is fitted, of which only a pressure sensing head of a pressure transmitter and a part of a flange around the pressure sensing head is shown.

FIG. 2 is a perspective rear view of the plywood formwork shown in FIG. 1, in which only a main body of the pressure transmitter and another part of the flange abutting the plywood formwork is shown.

FIG. 3 is an exploded side view of the formwork pressure measurement device shown in FIGS. 1 and 2, showing the flange separated from the pressure transmitter.

FIG. 4 is a perspective front view of a plastic formwork through which another embodiment of a formwork pressure measurement device of the invention is fitted.

FIG. 5 is a perspective rear view of the plastic formwork shown in FIG. 4.

FIG. 6 is an exploded side view of the formwork pressure measurement device shown in FIGS. 4 and 5.

FIG. 7 is similar to FIG. 4 but shows a flange being inserted into a through-hole of the plastic formwork from the front side thereof in a first step in the fitting of the device to the plastic formwork.

FIG. 8 is similar to FIG. 5 but shows a pressure transmitter then being inserted into the fitted flange from the rear side of the plastic formwork in a second step in the fitting of the device to the plastic formwork.

FIG. 9 is a side view of the pressure transmitter shown in FIG. 3, and also shows an enlarged schematic view of an elastic unit at a projecting surface of a pressure sensing head of the pressure transmitter in which a plurality of strain gauges are located.

FIG. 10 is a circuit diagram of a Wheatstone Bridge to which the strain gauges shown in FIG. 9 are connected so as to measure the deformation of the elastic unit.

FIG. 11 is another perspective rear view of the plywood formwork shown in FIG. 2, but which shows an electrical cable connecting the pressure transmitter to a pressure signal transmitter device.

FIG. 12 is another perspective rear view of the plastic formwork shown in FIG. 5, but which shows an electrical cable connecting the pressure transmitter to a pressure signal transmitter device.

### BEST MODE OF CARRYING OUT THE INVENTION

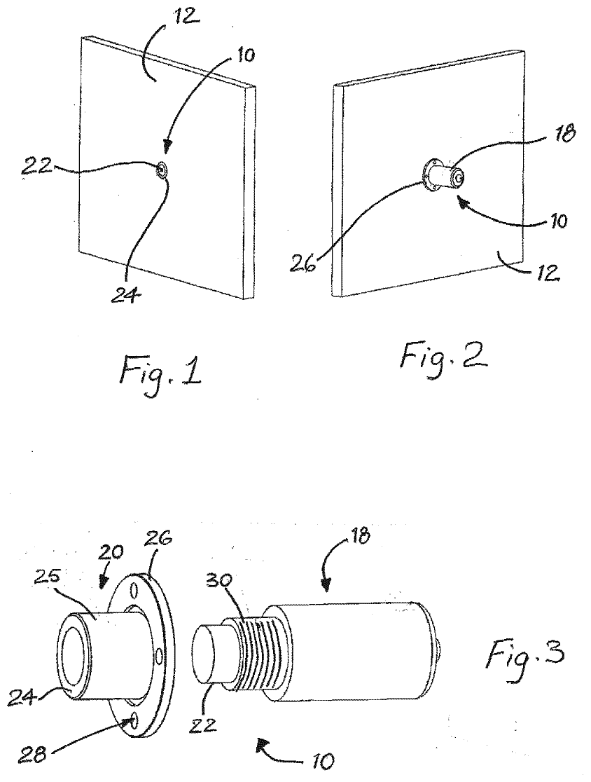

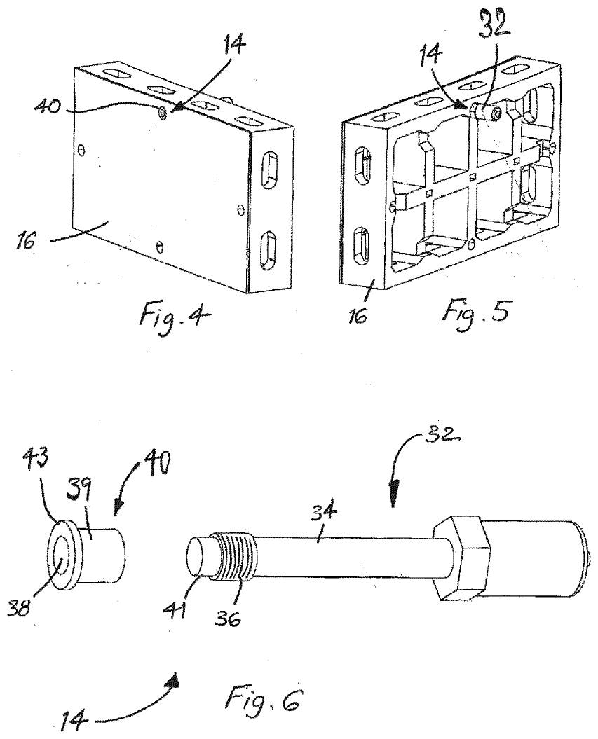

The formwork pressure measurement device 10 shown in FIGS. 1 to 3 is one embodiment of the present invention which is specifically designed to detect excessive pressure by wet (and still fluid) concrete which has been poured against a formwork panel, such as plywood formwork 12. The formwork pressure measurement device 14 shown in FIGS. 4 to 8 is another embodiment of the present invention designed for the same purpose, but for plastic formwork 16.

As shown in FIG. 3, the formwork pressure measurement device 10 has a pressure transmitter 18 and a flange 20 which serves as a mounting accessory for the pressure transmitter 18.

As shown in FIGS. 1 and 2, the formwork pressure measurement device 10 is configured to fit within the plywood formwork 12. The flange 20 is located in a through-hole of the formwork 12. As shown in FIG. 3, the pressure transmitter 18 has a sensor in the form of a pressure sensing head 22 which, when the device 10 is fitted in the formwork 12, is at least partly surrounded by the flange 20. Both the pressure sensing head 22 and an internal flange part 24 face a hollow space where wet concrete is to be poured against a front side of the formwork 12. The flange 20 has a main body 25.

As shown in FIG. 2, an external part 26 of the flange 20 is abutted against the rear side of the formwork 12 and is secured thereto by screws via mounting holes 28 in the flange. Then the pressure transmitter 18 is screwed into an internally partly-threaded part of the flange 20 via a male threaded part 30 (see FIG. 3).

The device 10 will then be able to measure the wet concrete pressure, while the concrete is being poured against the formwork 12.

In order to facilitate the fitting (or installation) of a formwork pressure measurement device 14, as shown in FIG. 6, to a plastic formwork 16, as shown in FIGS. 4 and 5, a pressure transmitter 32 having an extended structure is required to fit into the through-holes of the plastic formwork 16. As shown in FIG. 6, the pressure transmitter 32 has an extender rod 34, and there is a male threaded part 36 adjacent a free end of the rod 34. In use, the male threaded part 36 of the extender rod 34 is paired with an internally partly-threaded part 38 of a main body 39 of a flange 40 (or nut). The pressure transmitter 32 also has a sensor in the form of a pressure sensing head 41 which, when the device 14 is fitted in the formwork 16, is at least partly surrounded by the main body 39.

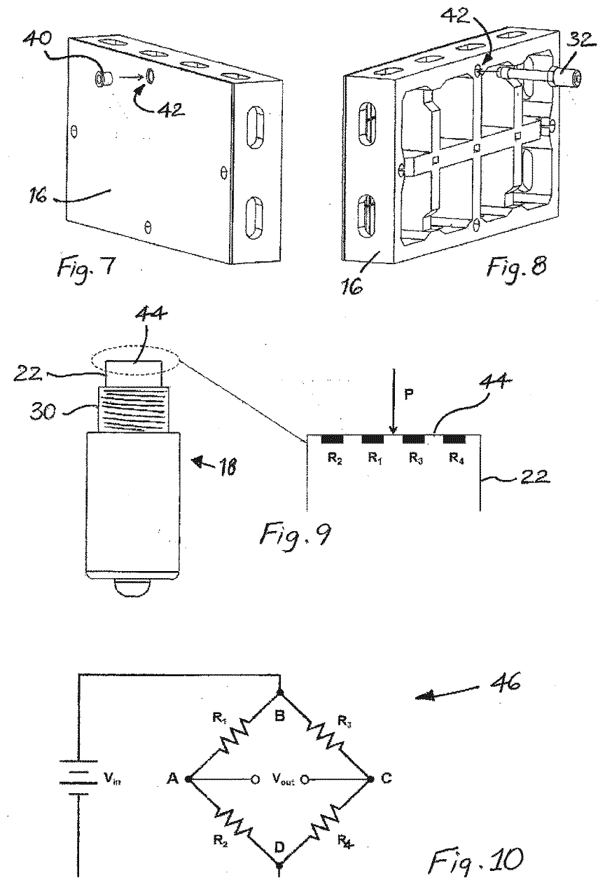

In the installation as shown in FIG. 7, the flange 40 is inserted into the formwork 16 via a through-hole 42 from the front side, whereas the pressure transmitter 32 is placed into the same hole 42 from the rear side of the formwork 16. Then the pressure transmitter 32 is screwed into the flange 40 via the male and female engaging threads 36, 38, thereby securing the pressure transmitter 32 against the formwork 16. Both the pressure sensing head 41 and an external rim 43 of the flange 40 face a hollow space where the wet concrete is to be poured against the front side of the formwork 16.

This approach avoids any modifications to the existing plastic formwork 16, and facilitates quick and easy device installation on site.

Depending on the functional applications, there exist different types of pressure transmitters which use generally common working principles. Considering the working environment and medium (i.e., wet or fluid concrete) under which the concrete pressure is to be measured, different types of pressure transmitters can be applied to measure the concrete pressure on the formwork, including strain gauge pressure transmitters, diffused silicon pressure transmitters which utilise a silicon diaphragm as an elastically deformable element, piezoresistive pressure transmitters which utilise a single crystal silicon wafer as an elastic element, ceramic pressure transmitters which utilise a ceramic diaphragm as an elastic element, and silicon-on-sapphire pressure transmitters.

The general working principle of a suitable concrete pressure transmitter for use in the present invention is that, when an elastic element (or elastic unit) of the transmitter experiences a change in concrete pressure, the elastic element undergoes a level of deformation proportional to the applied pressure, changing the electrical resistance value of sensors associated with a pressure sensing head of the transmitter, whereby the change in resistance is detected by a suitable circuit as a change in voltage across the circuit.

In FIGS. 1 to 8, and in the example below, a strain gauge pressure transmitter is used. The general working principle of a pressure transmitter suitable for use in the present invention will be apparent from this example.

The pressure transmitter 18 shown in FIG. 9 includes an elastic unit 44, where a plurality of strain gauges R₁, R₂, R₃ and R₄ are located in a desired array. The strain gauges are at a projecting surface of the elastic unit 44 which serves as the pressure sensing head 22 of the pressure transmitter 18. The pressure sensing head 22 of the transmitter 18 comprises a single, tubular piece of steel in the high-pressure range. When a concrete pressure P (see FIG. 9) is applied to the pressure sensing head 22 of the transmitter 18, the elastic unit 44 will be subject to physical stress changes and become deformed. The deformation of the elastic unit 44 can be measured by the array of strain gauges (i.e., R₁, R₂, R₃ and R₄) and analysed by measurement electronics. Note that the strain gauges are essentially resistors, whose resistances are changed according to the deformations of the strain gauges.

To measure the deformation of the elastic unit 44, the four strain gauges are connected to a Wheatstone Bridge 46, as shown in FIG. 10. The four strain gauges are arranged in the Wheatstone Bridge 46 as a quadrilateral ABCD. The excitation voltage Vin is applied between points B and D, whereas the voltage difference Vₒᵤₜ is measured between points A and C. When no pressure P is applied, the four strain gauges have the same resistance values, and the voltage output Vₒᵤₜ is zero. When a concrete pressure is applied to the elastic unit 44, the resulting deformation of the elastic unit will lead to a resistance change in the strain gauges, which will cause a change in voltage output Vₒᵤₜ. After amplification using an electronic amplifier, Vₒᵤₜ can be proportionally enlarged to a 0 to 3.2V voltage range output signal, corresponding to the deformation range of the elastic unit 44. As the relationship between the deformation of the elastic unit 44 and pressure applied is calibrated and known, the pressure value can be mapped using the output voltage Vₒᵤₜ.

The same or similar structures and functioning of a strain gauge array do also apply to the pressure transmitter 32 of the device 14.

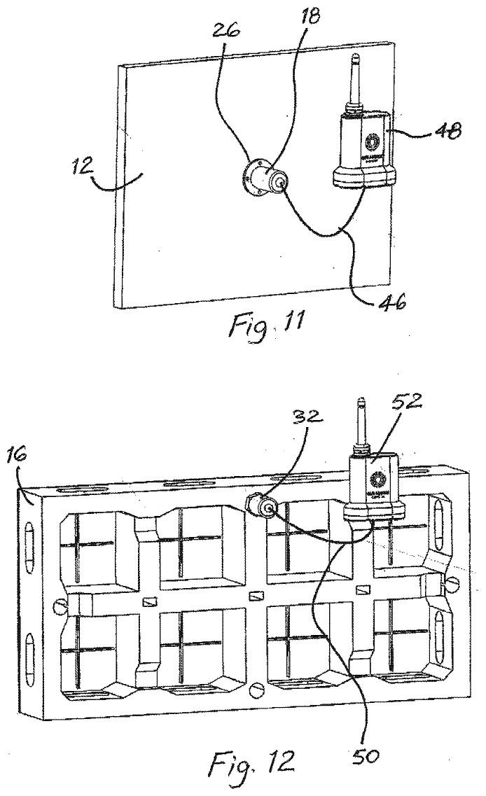

The pressure transmitter 18 of the formwork pressure measurement device 10 is connected via a direct electrical cable 46 to a formwork pressure signal transmitter device 48, as shown in FIG. 11. The pressure signal transmitter device 48 receives a pressure value from the pressure transmitter 18 and sends the value data wirelessly and in real time to a remote server for a monitoring system.

As shown in FIG. 12, the pressure transmitter 32 of the formwork pressure measurement device 14 is also connected via a direct electrical cable 50 to a pressure signal transmitter device 52. The pressure signal transmitter device 52 receives a pressure value from the pressure transmitter 32 and also sends the value data wirelessly and in real time to a remote server for a monitoring system.

The monitoring system is configured to determine if a specific concrete pressure value has been reached and will inform the user accordingly, in real time.

The pressure signal transmitter device 48, 52 linked to the formwork pressure measurement device 10, 14 will effectively be in an ON mode all the time to receive the pressure value data. A plurality of these devices 10, 48 and 14, 52 can communicate wirelessly and remotely via a Gateway which is networked to System Monitoring Software operating a central monitoring and control computer and/or a network of distributed computers.

Such a Gateway may be a LoRa-based Gateway which can receive and transmit signals over a distance of about 15 kilometres.

Communication between a LoRaWAN Gateway and the central monitoring and control computer and/or network of distributed computers is via existing Ethernet/Wi-Fi infrastructures or via mobile Internet (eg. 4G, 5G or IOT).

In this way, the devices of the present invention which are deployed on the formwork 12, 16 can continuously monitor the concrete pressure.

The devices of the present invention also provide feedback wirelessly via the Gateway.

Information received by a designated safety supervisor may be represented on a Dashboard-Graphic User Interface (GUI) of a remotely located, central monitoring and control computer and/or of a network of distributed computers. Such computers may include conventional desktop or laptop computers, smart phones and similar devices suitable for off-site monitoring and management of the safe use of the formwork.

When any of the devices of the present invention detect a predetermined pressure limit has been reached, an alert message or other alarm signal is immediately transmitted in an ALARM mode via the Gateway to the Dashboard-GUI indicating a trigger event or safety breach at the location of the affected device, and an email or SMS (text message) notification is sent to the designated safety supervisor and/or to a hierarchical chain of command.

Even after the initial alarm signal has been received, the other devices on the formwork continue in their ON mode and may communicate with one another to ensure the operational integrity of all other formwork structures on the formwork.

The pressure signal transmitter device in the ALARM mode continues to send alarm signals, either continuously or periodically, until the trigger event or safety breach has been resolved and the affected device has been redeployed to an ON mode.

The capturing and recording of data relating to trigger events and safety breaches is useful for the purpose of documenting unsafe practices, and quickly identifying the location of the breach and the person responsible for the breach. Because the alarm signal is triggered in real time, it is normally possible to identify the person responsible immediately, and this acts as a strong deterrent to workers creating over-pressured formwork structures.

The System Monitoring Software may be used to collect and display in real time the aforementioned data, statistics and other information for continuous safety management.

Among the information which may be displayed on the Dashboard-GUI is a graphical representation (in two or three dimensions) of the formwork showing the location and mode (or operational condition) of all the devices deployed on the formwork.

It will also be readily appreciated by persons skilled in this art, upon reading this description of embodiments of the invention, that there may be alternative embodiments of formwork pressure measurement devices and pressure signal transmitter devices for concrete formwork which fall within the scope of the present invention.

The reference in this specification to any prior publication (or information derived from it), or to any matter which is known, is not, and should not be taken as an acknowledgement or admission or any form of suggestion that that prior publication (or information derived from it) or known matter forms part of the common general knowledge in the field of endeavour to which this specification relates before the filing date of this patent application.

1. A formwork pressure measurement device comprising:
(a) a pressure transmitter adapted to be located at a rear side of a formwork, the pressure transmitter having a first engagement part and a pressure sensing head, and
(b) a flange adapted to be located in a through-hole of the formwork, the flange having a second engagement part,
wherein, in use, the first and second engagement parts are engaged together so that the pressure sensing head is at least partly surrounded by the flange and can measure the pressure of the concrete on the formwork.

2. The device of claim 1, wherein the pressure sensing head of the pressure transmitter, and an internal flange part of the flange, face a hollow space where wet concrete is to be poured against a front side of the formwork.

3. The device of claim 1, wherein an external part of the flange is abutted against the rear side of the formwork.

4. The device of claim 3, wherein the external part of the flange is secured to the rear side of the formwork by screws passed through mounting holes in the flange.

5. The device of claim 1, wherein the first and second engagement parts are engaged together by screwing a male threaded part of the pressure transmitter into an internally partly-threaded part of the flange.

6. The device of claim 1, wherein the pressure sensing head of the pressure transmitter, and an external rim of the flange, face a hollow space where wet concrete is to be poured against a front side of the formwork.

7. The device of claim 1, wherein the pressure transmitter has an extender rod, and there is a male threaded part adjacent a free end of the extender rod.

8. The device of claim 7, wherein the first and second engagement parts are engaged together by screwing a male threaded part of the extender rod into an internally partly-threaded part of the flange.

9. The device of claim 1, wherein the flange is inserted into the through-hole of the formwork from a front side of the formwork, and the pressure transmitter is inserted into the through-hole from the rear side.

10. The device of claim 1, wherein the pressure transmitter is a strain gauge pressure transmitter.

11. The device of claim 10, wherein the pressure sensing head of the strain gauge pressure transmitter comprises an elastic unit, wherein a plurality of strain gauges are located at a projecting surface of the elastic unit.

12. The device of claim 1, wherein the pressure transmitter is connected via a direct electrical cable to a formwork pressure signal transmitter device.

13. A formwork pressure signal transmitter device comprising:
(a) means for receiving a pressure value from a formwork pressure measurement device of claim 1, and
(b) means for wirelessly transmitting the pressure value as a signal in real time to a monitoring system for monitoring the concrete pressure in real time.

14. A method of measuring and transmitting the pressure of wet concrete against formwork, the method comprising:
(a) using a formwork pressure measurement device of claim 1 to measure the concrete pressure,
(b) connecting the formwork pressure measurement device to a formwork pressure signal transmitter device of claim 13, and
(c) sending a signal from the formwork pressure signal transmitter device representative of the measured concrete pressure wirelessly and in real time to a monitoring system.

15. The method of claim 14, further including the step of sending one or more electronic messages by SMS notification and/or email to one or more recipients recorded in a database in response to the pressure measured by the formwork pressure measurement device reaching an excessive pressure value.

16. A monitoring system for determining if a specific concrete pressure value has been reached when pouring concrete against formwork, the system comprising:
(a) a plurality of the formwork pressure measurement devices of claim 1 located on the formwork,
(b) a formwork pressure signal transmitter device of claim 13 connected to each of the formwork pressure measurement devices, and
(c) a remote server for receiving wirelessly and in real time a pressure value as a signal so that a user is alerted that the specific concrete pressure value has been reached.
